(19) United States
(12) Patent Application Publication
(10) Pub. No.: US 2009/0143253 A1
(43) Pub. Date: Jun. 4, 2009

(54) Drilling fluids containing microbubbles

(76) Inventors: Kevin W. Smith, Houston, TX (US); Taylor C. Green, Houston, TX (US)

Correspondence Address: William L. Krayer, 1771 Helen Drive, Pittsburgh, PA, 15216, US

(21) Appl. No.: 12/313,947

(22) Filed: Nov. 26, 2008

Related U.S. Application Data
(60) Provisional application No. 61/004,661, filed on Nov. 29, 2007.
(60) Provisional application No. 61/062,932, filed on Jan. 30, 2008.

(51) Int. Cl. B01F 17/00

(52) U.S. Cl. 507/102

(57) ABSTRACT

A drilling fluid comprises water and microbubbles in an amount to achieve a density of the fluid in the range of 4-6 pounds per gallon; the desired density is achieved, and the novel drilling fluid exists, at pressures in the range of 350-5000 pounds per square inch.

### RELATED APPLICATIONS

This application claims the full benefit of provisional application 61/004,661 filed Nov. 29, 2007 and provisional application 61/062,932 filed Jan. 30, 2008, both of which are specifically incorporated herein in their entireties.

### TECHNICAL FIELD

Microbubbles are created and dispersed in fluids used for drilling wells. The microbubbles are created by diffusing air through a microporous membrane tube wall into the drilling fluid passing under pressure in a cross flow mode, or by a cavitation device. Fluids having densities in the range of 4-6 pounds per gallon characterized by a uniform dispersion of microbubbles when the fluid is under high pressure are particularly useful as drilling fluids.

### BACKGROUND OF THE INVENTION

In the drilling of wells for hydrocarbon recovery, fluids are circulated in wellbores to remove drill cuttings. The fluids can range in weight from very near zero (gas) to as high as 24 pounds per gallon, for which weighting agents are added to liquid to impart a high specific gravity to assure the cuttings will have buoyancy in the fluid. A major factor in the choice of the weight of the fluid over this wide range is the pressure in the formation through which the wellbore is drilled. As a general rule, where the pressure in the formation is high, a heavier fluid will be used; if the pressure in the formation is relatively low, a lighter weight fluid will be prescribed for a balanced or underbalanced drilling process, in order not to injure the formation. A lighter fluid may be desirable also if the wellbore passes through a stratum of relatively low pressure even though the pressure may increase at greater depths, in order not to lose fluid unnecessarily into the formation in the low pressure area. In either case, the pump that circulates the fluid must be able to overcome the pressures of the formation as well as circulate the fluid. A triplex pump is commonly used for injecting and circulating the drilling fluid in the well.

Water weighs about 8.33 pounds per gallon, and has been used for decades in many different kinds of drilling environments by itself and as a base for many different kinds of drilling fluids, sometimes called drilling muds. Foaming agents have been used to reduce the weight of various aqueous drilling fluids, among other reasons. The industry has used foams of various types that are effective for limited or specified purposes, but a foam has a high percentage of gas and a small percentage of liquid and accordingly tends to weigh less than 2 pounds per gallon. In many situations, the ability of such light weight foam to carry drill cuttings is limited.

Foam is a distinct form of fluid. Foam is defined and used herein as bubbles in contact with one another such that the bubbles must deform for the fluid to move. Foams are true Bingham Plastic fluids typically with a very high yield point and plastic viscosity. While they can be very efficient fluids in well drilling, they are much harder to control than gas-free fluids. That is, one must control the pressure of the annular space so that the volume of gas does not expand to the point that the volume limit of the foam is exceeded and the bubbles interfere with one another. Typically foam has 62% to 90% gas by volume at a given pressure, and foam that is about 75% by volume gas generally may be expected to have better fluid properties than other percentages in a fluid of the same composition. There are recently developed methods to control annular pressure, but still there is a pressure differential from the bit to the surface. Controlling the annular pressure is complicated by the need to remove cuttings from the system. Foam has a further disadvantage of high friction. Since the bubbles must deform to move, there is high wall friction inside of the drill pipe. Therefore it is common to try to make the foam at the drill bit to avoid contact of the descending foam with the drill pipe; however, it is difficult to control the addition of gas to the fluid at the drill bit, and because there is less control of the fluid, gravity and coalescence can cause the gas and liquid to arrive at the bit in slugs.

Light, non-foam, or non-foaming, drilling fluids in the range of 4-6 pounds per gallon would be desirable in many situations because a lighter hydrostatic column means the drilling can proceed at a faster pace and frequently with less energy expended. Such a light, non-foaming, fluid would be able to carry the cuttings efficiently, but is not practically available in the industry. A practical way to make such a fluid has eluded the art.

As is known in the art, aerated drilling systems used in the past—that is, foam systems—inject the air or other gas after, downstream of, the triplex pump, because the triplex pump is liable to form large bubbles by coalescing small ones, which can cause major damage to the pump and/or otherwise cause a disruption of the system if the air is injected by conventional means ahead of or in the triplex pump. Air injection systems used in the past have themselves been a large part of the problem. The triplex pump may become locked if a large bubble of air passes into it or is formed within it by cavitation or any other phenomenon such as simple coalescence. Even a centrifugal pump is highly likely to become air locked if more than 6% air by volume is introduced into the pump by way of conventional foam-forming aeration systems.

A practical way of placing non-foam bubbles in the fluid to decrease the weight of the fluid downstream of the triplex pump, in the high pressures present, has eluded the art. The range of drilling fluid weights from about 4 to about 6 pounds per gallon has been especially difficult to attain by any means. Likewise, a convenient way of reducing the weight of fluids containing desirable heavy components has eluded the art. Our invention provides light weight drilling fluids containing microbubbles; especially useful are the drilling fluids of our invention having a weight (density) of 4-6 pounds per gallon.

In the art of foamed plastics and the like, a foamed product in which the voids are substantially contiguous, such as in a honeycomb, is known as a cellular foam. A solid synthetic plastic containing numerous dispersed, non-contiguous voids (isolated gas-filled vesicles) is known as a syntactic foam. Our drilling fluid is a liquid analog to a solid syntactic foam. That is, we distinguish our new drilling fluids from true liquid foams, in which the voids (gas-filled areas) are contiguous, separated only by a thin deformable wall of liquid. Our new drilling fluid comprises a gas dispersed as microbubbles in the drilling fluid, and accordingly we refer to the fluid containing the microbubbles as syntactic gas-containing fluid or simply syntactic fluid. Specifically, our new drilling fluid is referred to herein as syntactic microbubble drilling fluid. Where the bubbles in our fluid are less than about 1000 nanometers in diameter, they may be called colloidal suspensions of the gas in the liquid, since they are generally uniformly dispersed and substantially non-contiguous, bearing in mind that the drilling fluid frequently flows turbulently. Where the bubbles are greater than 1000 nanometers in diameter, they are nevertheless dispersed and substantially noncontiguous.

### SUMMARY OF THE INVENTION

Our invention is a light weight drilling fluid comprising a liquid having a large number of microbubbles dispersed substantially uniformly within it. The drilling fluid containing evenly dispersed microbubbles desirably weighs (has a density of) 4-6 pounds per gallon of fluid.

Our invention also includes a drilling fluid comprising water and non-contiguous microbubbles in an amount sufficient to reduce the weight of the drilling fluid to within the range 4-6 pounds per gallon under an operating drilling pressure ranging from 350 psi to 5000 psi.

In addition, our invention includes a drilling fluid comprising a liquid, drilling fluid additives, and non-foamed microbubbles having diameters of 100 nanometers to 100 microns, and especially those in the range of 20-40 microns. Microbubbles in the range of 100 nanometers diameter to 100 microns diameter are especially useful in amounts to reduce the weight of the base drilling fluid including drilling fluid additives by at least 10% and especially at least 25%.

In addition to satisfying the primary objective of providing a light weight fluid, using microbubbles provides a number of advantages compared to foam. Microbubbles do not need to deform to flow; therefore, the carrier fluid determines the properties of the microbubble suspension. Also, unlike the foam, microbubbles will reduce friction—the resistance to flow due to contact with conduit walls.

The microbubbles are injected into the drilling fluid by forcing gas through the pores of a microfilter, microporous membrane, or other microporous medium, or by generating them with a cavitation device, as will be explained below.

Our drilling fluid cannot exist at atmospheric pressure because it incorporates a larger amount of gas than can be contained at atmospheric pressure. Therefore it is to be understood that a definition or description of our new drilling fluid in terms of the amount of gas contained in it implies that the pressure and temperature conditions must be present to sustain it. The absolute amount of gas, in terms of moles, molecules, or mass, is very large compared to the amount that can be retained in the fluid at atmospheric pressures and ambient temperatures. Thus our new drilling fluid may also be characterized by a range of density, which may be expressed in conventional oilfield usage, in pounds per gallon. For the practical purpose of controlling an underbalanced drilling program, it will be understood that the density of an entire hydrostatic column of drilling fluid will profoundly affect the hydrostatic head and the pressure at the bottom of the well.

Readers familiar with Kepler's conjecture and the theory of sphere packing will know that the volume occupied by spheres of uniform size packed in a space cannot exceed about 74% of the space. The spheres in Kepler's conjecture are all contiguous, however, touching each other at a single point, unlike the microbubbles in our invention, which are substantially dispersed. Thus the drilling fluid in our invention may be said never to include as much as 74% gas by volume in the form of uniformly dispersed microbubbles.

Using microbubbles provides a number of advantages compared to foam. Microbubbles do not need to deform to flow; therefore, the base fluid is the primary determinant of the flow properties of the microbubble suspension. At the same time, the microbubbles will reduce friction when the fluid flows under high pressure.

### BRIEF DESCRIPTION OF THE DRAWINGS

FIGS. 1a, 1b and 1c illustrate a cavitation device useful for making and dispersing the microbubbles useful in our invention.

FIG. 2 illustrates a membrane device for making and dispersing microbubbles into a base drilling fluid.

FIGS. 3, 4, 5, and 6 are graphic illustrations of portions of Tables 4, 5, 6, and 7, showing the relationships of air and water under various densities and pressures.

### DETAILED DESCRIPTION OF THE INVENTION

As is known in the art, a triplex pump is able to send the drilling fluid down the well to the bottom where the drill is creating cuttings, so the fluid will pick up the cuttings, and raise them to the surface. In doing so, the pump must apply enough pressure to overcome the formation pressure. The downhole pressure may typically be in the order of 1000 psi, 2000 psi (pounds per square inch) or more, or as much as 5000 psi. The increased pressure causes any bubbles present in the drilling fluid to be compressed and reduced in volume. This compressing effect in turn increases the ratio by volume of liquid to gas in the fluid, which increases the weight of the fluid per gallon, tending to counteract the main effect of the bubbles, to reduce the weight of the liquid.

Bearing in mind that water weighs about 8.33 pounds per gallon (ppg), that water is essentially incompressible, and that our objective is to obtain a fluid in the well having a weight of 4-6 ppg, a gallon of water containing bubbles requires that the bubbles occupy from 28% to 52% of the volume of the fluid after injection, at a high pressure, without forming a foam. This would be extremely difficult to do with conventional air or gas injection techniques on the downstream side of the triplex pump, where the pressure may already be at the 2000 psi level. Placing this much air or gas in the liquid within the triplex (charge) pump or upstream of it with conventional air injection techniques has not been successfully done in the past. Accordingly, we use different techniques. Moreover, in fact, the weight and compression of the air or other gas should not be ignored.

The volume of the gas bubbles is inversely related to the pressure according to the Ideal Gas Law, PV=nRT, where P is pressure, V is volume, n is the amount of gas, which may appear in terms of the number of molecules of gas, T is the temperature, and R is a constant. The difficulty of the problem, therefore, may be seen if it is imagined that one is attempting to introduce enough bubbles at atmospheric pressure so that a gallon of drilling fluid subjected to a pressure, for example, of 2000 psi or higher, will contain dispersed bubbles comprising a very high percentage of its volume. A bubble introduced or present in the fluid at atmospheric pressure (14.7 psi) but later subjected to a pressure of 2000 psi would be compressed by a factor of 2000/14.7 or 136 (although a high downhole temperature will have a somewhat mitigating effect), which means that if a large number of compressed bubbles are present in a gallon of fluid at 2000 psi (now weighing, say, 5 pounds per gallon and 40% of its volume is bubbles), the bubbles must have a total volume of 0.4×136 gallons, or more than 54 gallons at atmospheric pressure.

Generally, small bubbles are more desirable than large bubbles, as they will not coalesce as easily as larger ones, and dispersions of smaller bubbles are known to be more stable than dispersions of larger ones. We generate bubbles in the drilling fluid having diameters from 100 nanometers to 100 micrometers, which we will refer to herein as “microbubbles.” A distinct advantage of microbubbles in our invention is that, because they are more numerous for a given volume of gas and have a larger total surface area for a given gas volume (surface area is a square function for a bubble and volume is a cube function), they will provide a significant reduction in friction in the drill pipe. Not only are microbubbles more numerous for a given total volume, but the ratio of surface area to volume is greater for a given volume of gas distributed in more but smaller bubbles. Friction reduction in the hydrocarbon recovery art, typically accomplished by water soluble polymer additives, has been recognized for decades as a highly desirable way of conserving and reducing the energy required to pump fluids through long series of pipes.

Our invention obviates the daunting problems presented by injecting bubbles at atmospheric pressure for use at much higher pressures.

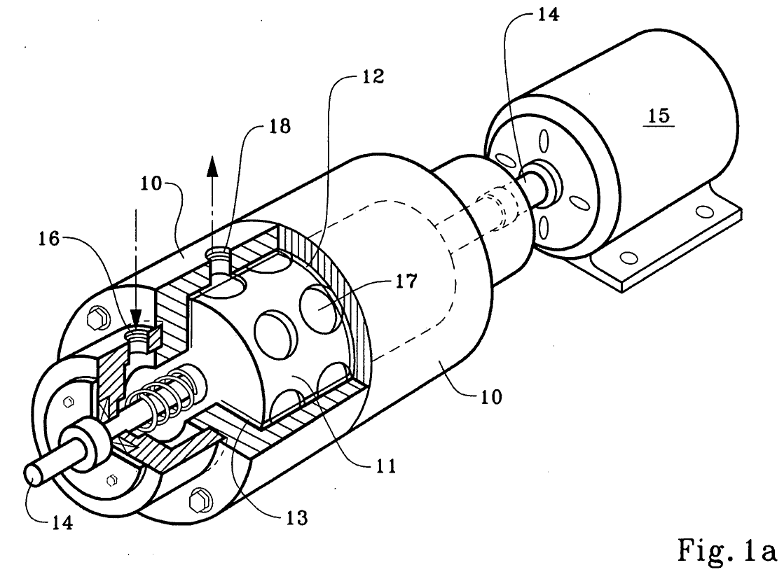

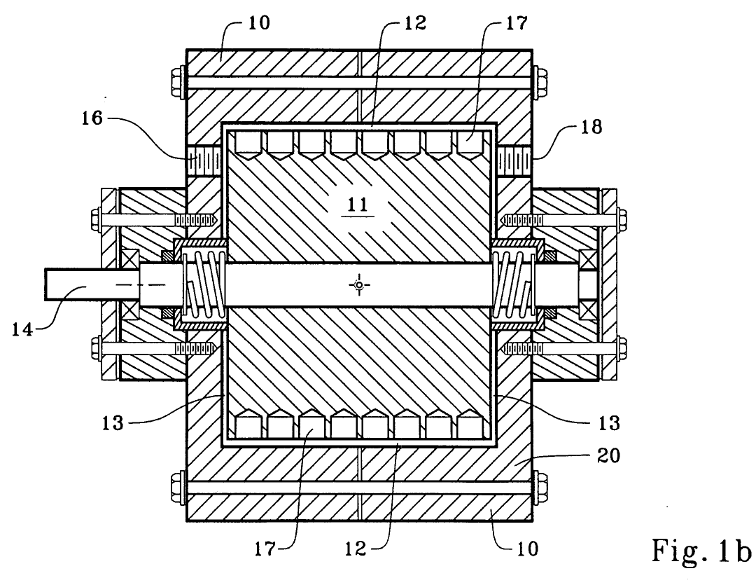

Referring now to FIGS. 1a and 1b, FIGS. 1a and 1b show two slightly different variations, and views, of a cavitation device_useful for making microbubbles in drilling fluids. FIGS. 1a and 1b are taken from FIGS. 1 and 2 of Griggs U.S. Pat. No. 5,188,090, which is incorporated herein by reference along with related U.S. Pat. Nos. 5,385,298, 5,957,122, and 6,627,784, all describing devices manufactured and sold by Hydro Dynamics, Inc., of Rome, Ga. In recent years, Hydro Dynamics, Inc. has adopted the trademark “Shockwave Power Reactor” for its cavitation devices, and I sometimes use the term SPR herein to describe the products of this company and other cavitation devices that can be used in our invention.

A housing 10 in FIGS. 1a and 1b encloses cylindrical rotor 11 leaving only a small clearance 12 around its curved surface and clearance 13 at the ends. The rotor 11 is mounted on a shaft 14 turned by motor 15. Cavities 17 are drilled or otherwise cut into the surface of rotor 11. As explained in the Griggs patent, other irregularities, such as shallow lips around the cavities 17, may be placed on the surface of the rotor 11. Some of the cavities 17 may be drilled at an angle other than perpendicular to the surface of rotor 11—for example, at a 15 degree angle. Liquid (fluid)—in the case of the present invention, a drilling fluid, —is introduced through port 16 under pressure and enters clearances 13 and 12. As the fluid passes from port 16 to clearance 13 to clearance 12 and out exit 18 while the rotor 11 is turning, areas of vacuum are generated and heat is generated within the fluid from its own turbulence, expansion and compression (shock waves). As explained at column 2 lines 61 et seq in the Griggs U.S. Pat. No. 5,188,090, “(T)he depth, diameter and orientation of (the cavities) may be adjusted in dimension to optimize efficiency and effectiveness of (the cavitation device) for heating various fluids, and to optimize operation, efficiency, and effectiveness . . . with respect to particular fluid temperatures, pressures and flow rates, as they relate to rotational speed of (the rotor 11).” Smaller or larger clearances may be provided (col. 3, lines 9-14). Also the interior surface of the housing 10 may be smooth with no irregularities or may be serrated, feature holes or bores or other irregularities as desired to increase efficiency and effectiveness for particular fluids, flow rates and rotational speeds of the rotor 11. (col. 3, lines 23-29) Rotational velocity may be on the order of 5000 rpm (col 4 line 13). The diameter of the exhaust ports 18 may be varied also depending on the fluid treated. Note that the position of exit port 18 is somewhat different in FIGS. 1a and 1b; likewise the position of entrance port 16 differs in the two versions and may also be varied to achieve different effects in the flow pattern within the SPR.

Definition: We use the term “cavitation device,” or “SPR,” to mean and include any device which will cause bubbles or pockets of partial vacuum to form within the liquid it processes. The bubbles or pockets of partial vacuum have also been described as areas within the liquid which have reached the vapor pressure of the liquid. The turbulence and/or impact, which may be called a shock wave, caused by the implosion imparts thermal energy to the liquid, which, in the case of water, may readily reach boiling temperatures. The bubbles or pockets of partial vacuum are typically created by flowing the liquid through narrow passages which present side depressions, cavities, pockets, apertures, or dead-end holes to the flowing liquid; hence the term “cavitation effect” is frequently applied, and devices known as “cavitation pumps” or “cavitation regenerators” are included in our definition. Steam generated in the cavitation device can be separated from the remaining, now concentrated, water and/or other liquid which frequently will include significant quantities of solids small enough to pass through the reactor. Cavitation devices can be used to heat fluids, but in our invention we use them to make microbubbles which are intended not to implode, but to remain in bubble form. To do this, a gas is injected along with the liquid, and the conditions controlled to generate microbubbles.

The term “cavitation device” includes not only all the devices described in the above itemized U.S. Pat. Nos. 5,385,298, 5,957,122 6,627,784 and 5,188,090 but also any of the devices described by Sajewski in U.S. Pat. Nos. 5,183,513, 5,184,576, and 5,239,948, Wyszomirski in U.S. Pat. No. 3,198,191, Selivanov in U.S. Pat. No. 6,016,798, Thoma in U.S. Pat. Nos. 7,089,886, 6,976,486, 6,959,669, 6,910,448, and 6,823,820, Crosta et al in U.S. Pat. No. 6,595,759, Giebeler et al in U.S. Pat. Nos. 5,931,153 and 6,164,274, Huffinan in U.S. Pat. No. 5,419,306, Archibald et al in U.S. Pat. No. 6,596,178 and other similar devices which employ a shearing effect between two close surfaces, at least one of which is moving, such as a rotor, and at least one of which has cavities of various designs in its surface as explained above.

Operation of the SPR (cavitation device) is as follows. A shearing stress is created in the solution as it passes into the narrow clearance 12 between the rotor 11 and the housing 10. The solution quickly encounters the cavities 17 in the rotor 11, and tends to fill the cavities, but the centrifugal force of the rotation tends to throw the liquid back out of the cavity. The SPR is frequently used to heat liquids, but small bubbles, some of them microscopic, are formed when it is so employed. Where no gas is present by injection, the small bubbles are imploded. The relatively large amount of gas present in the liquid in our invention (see FIG. 1c), however, preserves the bubbles as microbubbles, and in fact the shearing and cavitation within the device will continuously break up larger bubbles into smaller ones of substantially uniform size.

FIG. 1c is adapted from FIG. 1 of Hudson U.S. Pat. No. 6,627,784, one of the patents incorporated in its entirety by reference. FIG. 1c shows a cavitation device differing slightly from the cavitation device of FIGS. 1a and 1b. In FIG. 1c, drilling mud in conduit 60 is mixed with gas, usually air, from conduit 61. The gas immediately becomes dispersed in the form of bubbles 62 in conduit 63, which is split in two parts to enter the cavitation device at opposite sides of the rotor 64, which is mounted on shaft 70. As illustrated for the similar cavitation device in FIGS. 1a and 1b, the fluid enters clearance 65 and becomes subjected to the cavitation action imparted by passage of the bubble-containing drilling mud between rotating rotor 64, containing cavities 68, and housing 66. The gas immediately is broken into small bubbles which are formed into evenly dispersed microbubbles in the drilling mud 69 before it exits through conduit 67.

The cavitation device should be run at maximum design speed for maximum tip speed. More cavitation is better for mixing. The microbubbles will be substantially uniform in size if the flow rates of the liquid and gas are maintained substantially constant. The triplex pump will need a certain charge pressure that is up to 150 psi and then will pump the fluid to an order of magnitude higher pressure. Typically the circulating pressure of the well will be 350 to 5000 psi.

For best results at startup, one should prime the pumps with liquid and start flowing through the SPR running at speed before introducing gas into the system. That is fluid is forced through the SPR then through the downhole high pressure pump. Once the SPR is running gas is injected just before the SPR where it is mixed into the liquid by cavitation. The controlled cavitation in the SPR creates micro-bubbles in the 100 nanometer to 100 micrometer size range depending on speed and mixing time in the SPR. Because the increased pressure downstream of the pump will tend to compress the bubbles, smaller bubbles are preferred. That is, since gas is compressible and water is not, you must know the pressure of the system to calculate the volume of gas required to make up the final ratio of gas to liquid at bottom hole conditions. Smaller bubbles are a benefit and an increase in pressure from the top of the hole to the bottom of the hole helps create smaller bubbles.

Because surface area is a square function and volume is a cubed function, smaller bubbles will provide far greater surface area than larger bubbles for a given volume of gas in the fluid. This contributes to the stability of the dispersion of microbubbles and reduces friction against the walls of the well conduits.

FIG. 2 is a more or less diagrammatic illustration of a membrane microbubble machine. A liquid base drilling mud is introduced through line 80 to header 91 and distributed to the interiors of membrane tubes 92, which are fixed in sealed relation to header 91 and a collector 93. Membrane tubes 92 are hollow tubes comprised of a porous cylindrical support covered by a membrane of specified porosity. The cylindrical supports are made of many different materials such as polymers, reinforced plastics, and porous ceramics, and the membranes also can vary considerably in composition, being also typically made of various porous polymeric, metal or ceramic materials. In some cases, the support and the membrane may comprise the same material. The membrane tubes are contained in a housing 94. Compressed air (gas) inters housing 94 through line 6 and fills the spaces between the membrane tubes 92. The compressed air in line 6 is under high pressure, generally above 250 psi, and frequently much higher, i.e. 2000 psi or as high as 5000 psi. The housing 94, header 91, and collector 93, together with incoming line 6 for air, line 80 for drilling fluid, and line 55, for removing the fluid from the housing, must accordingly all be engineered to withstand the expected pressures. Air or other gas in line 6 and in the spaces between the membrane tubes 92 is maintained at a pressure higher than the pressure of the base drilling fluid within the membrane tubes 92, which causes the air to pass through the membranes and supports of the membrane tubes 92 and enter the liquid drilling fluid in the form of microbubbles 95. Base drilling fluid containing microbubbles 95 is collected in collector 93 and passed to line 55 as a light weight drilling fluid.

Operation of the microbubble machine 13, as indicated above, requires that the air pressure between the membrane tubes 92 be higher than the fluid pressure within their interiors. Pressure within the membrane tubes will be affected by the original pressure in line 80, but also by flow rates within the membrane tubes, which in turn may be affected by the decreasing density or increasing volume of the fluid as it passes through the tubes, picking up microbubbles. Another factor will be the size of the membrane pores; smaller pores require greater gas pressure to assure the gas passes through the membrane tube walls, although this effect may be ameliorated by a larger number of pores. Generally, the transmembrane pressure difference should be at least 50 psi; for most uses, a transmembrane pressure difference of 75-200 psi may be used.

The membrane tubes 12 are, or can be, filter tubes having membranes on the outside of a porous support. For our purposes, the outer membrane surface may be called the gas side and the internal side may be called the permeate side. The membranes will have pores of from 100 nanometers to 100 micrometers in diameter, or desirably from 0.1 to 50 microns. A transmembrane pressure difference of 100 psi is sufficient to transport bubbles copiously from the void space inside the vessel—actually filled with very high pressure gas—from the gas side of the membrane through the permeate side, through the porous support and into the flowing, high pressure liquid within the membrane tubes. Transmembrane pressure differences ranging from 50 to 150 psi will not damage most commercially available membrane tubes even though the pressure on both sides of the membrane and its support may exceed 4000 psi.

While the rate of diffusion through the membranes is directly related to the transmembrane pressure difference, the volume of gas bubbles taken in per gallon of fluid is also directly related to the flow rate of fluid through the membrane tubes; accordingly the fluid flow rate should be taken into account.

The following computational examples will illustrate the variations in gas content and drilling fluid densities included in our invention.

### EXAMPLE 1

Here, air bubbles having a volume of 0.001 cubic inch are introduced into the drilling fluid. That is, each bubble has a volume equivalent to a cube measured at 0.1 inch on each side, at the time they are introduced. In Table 1, air bubbles are introduced to the base drilling fluid at 100 psig, at 100° F., and the temperature is assumed to remain at 100° F. throughout the table. For this series of computations, 138,609 bubbles were assumed to be introduced per gallon of mixed fluid at 100 psi, thus providing a volume to volume ratio of air to liquid of 60:40 at a pressure of 100 psi. Although the drilling fluid may contain various dissolved and solid additives, the liquid portion of the drilling fluid is assumed, for purposes of the calculations, to be water having a density of 8.33 pounds per gallon. Table I shows the effects of increasing pressures after the bubbles are introduced. Following the Ideal Gas Law, the bubbles are compressed and significantly reduced in size, constantly changing the density of the mixed drilling fluid as the pressure is increased, as normally may be expected as drilling proceeds. Densities in the range of 4-6 pounds per gallon are achieved within the range of 100-200 psig.

TABLE 1
138,609 bubbles per gallon¹ introduced at 100 psig

| | | | | weight of the | weight of the | |
|---|---|---|---|---|---|---|
| | volume | total area | total volume | liquid portion | air portion | density of |
| | of one | of all | of all bubbles | of a gallon | of a gallon | mixed fluid |
| psig | bubble | bubbles | (cubic inches | (pounds) | (pounds) | (ppg) |
| 100 | 0.001 | 6691.5397 | 138.609 | 3.332021635 | 0.0444385 | 3.376460135 |
| 200 | 0.0005 | 4215.4059 | 69.3045 | 5.831010817 | 0.0444385 | 5.875449317 |
| 300 | 0.000333 | 3216.9567 | 46.203 | 6.664007212 | 0.0444385 | 6.708445712 |
| 400 | 0.00025 | 2655.5393 | 34.65225 | 7.080505409 | 0.0444385 | 7.124943909 |
| 500 | 0.0002 | 2288.4744 | 27.7218 | 7.330404327 | 0.0444385 | 7.374842827 |
| 600 | 0.000167 | 2026.5558 | 23.1015 | 7.497003606 | 0.0444385 | 7.541442106 |
| 700 | 0.000143 | 1828.6364 | 19.80128571 | 7.616003091 | 0.0444385 | 7.660441591 |
| 800 | 0.000125 | 1672.8849 | 17.326125 | 7.705252704 | 0.0444385 | 7.749691204 |
| 900 | 0.000111 | 1546.5515 | 15.401 | 7.774669071 | 0.0444385 | 7.819107571 |
| 1000 | 0.0001 | 1441.6485 | 13.8609 | 7.830202163 | 0.0444385 | 7.874640663 |

¹One gallon = 231.016 cubic inches
²Density of air at 100 psi is taken as 0.07406417 pounds per gallon
³138.609 cubic inches is 60% of the volume of a gallon.
⁴A bubble having a volume of .001 in³ has a diameter of 0.12407 inch.

### EXAMPLE 2

For the calculations of Table 2, 115,508 bubbles of 0.001 cubic inch were assumed to be introduced into the base drilling fluid (having an assumed density of 8.33 ppg, the density of water) at 500 psi. The density of the air, under a pressure of 500 psi, was already 0.33155 pounds per gallon at the time of introduction. Again, all data assume a constant temperature of 100° F. As in Table 1, the calculations show the effects of increasing pressures, this time beginning at 500 and proceeding to 1500 psig. Densities in the range of 4-6 ppg are achieved.

TABLE 2
115,508 bubbles introduced at 500 psi

| | | | | weight | weight | |
|---|---|---|---|---|---|---|
| | volume of one | | total volume | of liquid | of air | density of |
| pressure | bubble | total surface | of all bubs | in a gallon | in a gallon | mixed Fluid |
| psig | (cubic inch) | of all bubbles | (cubic inch) | (pounds) | (pounds) | (ppg) |
| 500 | 0.001 | 2780.686075 | 115.508 | 4.165 | 0.165775 | 4.330775 |
| 600 | 0.000833333 | 2462.433238 | 96.2566667 | 4.859167 | 0.165775 | 5.024942 |
| 700 | 0.000714286 | 2221.944831 | 82.5057143 | 5.355 | 0.165775 | 5.520775 |
| 800 | 0.000625 | 2032.693852 | 72.1925 | 5.726875 | 0.165775 | 5.89265 |
| 900 | 0.000555556 | 1879.188266 | 64.1711111 | 6.016111 | 0.165775 | 6.181887 |
| 1000 | 0.0005 | 1751.72246 | 57.754 | 6.2475 | 0.165775 | 6.413275 |
| 1100 | 0.000454545 | 1643.880239 | 52.5036364 | 6.436818 | 0.165775 | 6.602594 |
| 1200 | 0.000416667 | 1551.235736 | 48.1283333 | 6.594583 | 0.165775 | 6.760359 |
| 1300 | 0.000384615 | 1470.628789 | 44.4261538 | 6.728077 | 0.165775 | 6.893852 |
| 1400 | 0.000357143 | 1399.737532 | 41.2528571 | 6.8425 | 0.165775 | 7.008275 |
| 1500 | 0.000333333 | 1336.814432 | 38.5026667 | 6.941667 | 0.165775 | 7.107442 |

1. Density of air at 500 psi = 0.33155 ppg.
2. 115.508 cubic inches is one-half gallon.

### EXAMPLE 3

In this calculated example, 115,508 air bubbles of 0.001 cubic inch are introduced at 1000 psig and the pressure is increased in 100 psi increments. As in tables 1 and 2, the air portion of the mixed gallon volume decreases in volume in accordance with the Ideal Gas Law, and the liquid portion increases inversely. The weight of the air is included in the computations to provide the final density in the column titled “density of mixed fluid.” Again, the densities are within the range of 4-8 pounds per gallon, and other values within the range may be projected or interpolated, although, as noted elsewhere herein, amounts of dissolved air are not considered.

TABLE 3
115,508 Bubbles per Gallon Introduced at 1000 psi

| | | | | weight | weight | |
|---|---|---|---|---|---|---|
| | volume of one | total surface | total volume | of the liq | of the air | density of |
| | bubble | of all bubbles | of all bubs | portion of | portion of | mixed fluid |
| psig | (cubic inch) | (sq. inches) | (cubic inch) | a gallon | a gallon¹ | (ppg) |
| 1000 | 0.001 | 2780.68608 | 115.508 | 4.165 | 0.32754 | 4.49254 |
| 1100 | 0.00090909 | 2609.49722 | 105.007273 | 4.54363636 | 0.32754 | 4.87117636 |
| 1200 | 0.00083333 | 2462.43324 | 96.2566667 | 4.85916667 | 0.32754 | 5.18670667 |
| 1300 | 0.00076923 | 2334.47769 | 88.8523077 | 5.12615385 | 0.32754 | 5.45369385 |
| 1400 | 0.00071429 | 2221.94483 | 82.5057143 | 5.355 | 0.32754 | 5.68254 |
| 1500 | 0.00066667 | 2122.06064 | 77.0053333 | 5.55333333 | 0.32754 | 5.88087333 |
| 1600 | 0.000625 | 2032.69385 | 72.1925 | 5.726875 | 0.32754 | 6.054415 |
| 1700 | 0.00058824 | 1952.1777 | 67.9458824 | 5.88 | 0.32754 | 6.20754 |
| 1800 | 0.00055556 | 1879.18827 | 64.1711111 | 6.01611111 | 0.32754 | 6.34365111 |
| 1900 | 0.00052632 | 1812.65949 | 60.7936842 | 6.13789474 | 0.32754 | 6.46543474 |
| 2000 | 0.0005 | 1751.72246 | 57.754 | 6.2475 | 0.32754 | 6.57504 |
| 2100 | 0.00047619 | 1695.66126 | 55.0038095 | 6.34666667 | 0.32754 | 6.67420667 |
| 2200 | 0.00045455 | 1643.88024 | 52.5036364 | 6.43681818 | 0.32754 | 6.76435818 |
| 2300 | 0.00043478 | 1595.87941 | 50.2208696 | 6.51913043 | 0.32754 | 6.84667043 |
| 2400 | 0.00041667 | 1551.23574 | 48.1283333 | 6.59458333 | 0.32754 | 6.92212333 |
| 2500 | 0.0004 | 1509.58865 | 46.2032 | 6.664 | 0.32754 | 6.99154 |
| 2600 | 0.00038462 | 1470.62879 | 44.4261538 | 6.72807692 | 0.32754 | 7.05561692 |
| 2700 | 0.00037037 | 1434.08905 | 42.7807407 | 6.78740741 | 0.32754 | 7.11494741 |
| 2800 | 0.00035714 | 1399.73753 | 41.2528571 | 6.8425 | 0.32754 | 7.17004 |
| 2900 | 0.00034483 | 1367.37184 | 39.8303448 | 6.8937931 | 0.32754 | 7.2213331 |
| 3000 | 0.00033333 | 1336.81443 | 38.5026667 | 6.94166667 | 0.32754 | 7.26920667 |

¹Assumed density of air at 1000 psi = 0.65508 ppg.

It will be seen from tables 1, 2, and 3 that introducing bubbles at pressures significantly higher than atmospheric enables the production of drilling fluids having densities significantly less than 8 pounds per gallon. While doubling the pressure thereafter will reduce the volume of bubbles by half (note that, in Table 3, the air occupies only one-fourth of the paradigmatic gallon at 2000 psi), the total surface area of the bubbles is not reduced at the same rate, as the surface is a square function of the radius while the volume is a cube function. The surface area of the bubbles is significant for enhancing the flow characteristics of the drilling fluid.

Tables 1, 2, and 3 assume that the bubbles continue to exist as bubbles throughout even though they may become very small. Any air which is dissolved in the fluid is not considered; that is, dissolved air may be present in addition to the free air bubbles. The tables may therefore be used as a rule of thumb, recognizing that Henry's Law requires that at least some air will be dissolved. The dissolution rate will be affected, however, not only by the vagaries of Henry's Law, but also by the other ingredients of the drilling fluid, dissolved or not. Dissolved salts generally may be expected to reduce the air dissolution rate, while bubbles may be attracted to suspended solids. Another caveat about the tables is that the volumes of the bubbles at higher pressures will be compressed to approach colloidal size, and various additional phenomena of colloid chemistry and physics may affect the basic relationships represented in the tables.

### EXAMPLE 4

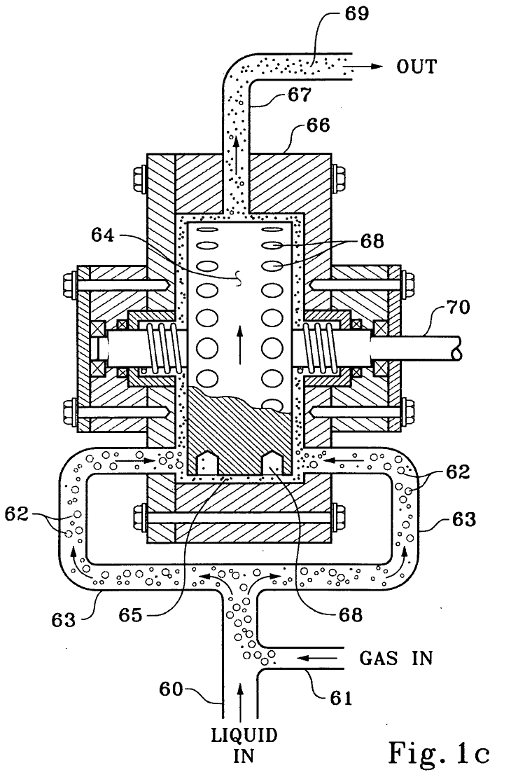

In Table 4, the calculations show the amount of air used to achieve densities between 4 and 6 pounds per gallon of mixed drilling fluid, together with pressures associated with such fluids. Again, all values are at 100° F. Data from Table 4 are depicted graphically in FIG. 3.

The compressed air volume is expressed in cubic millimeters in the last column of Table 4 for convenience in determining the number of bubbles required. As indicated above, I prefer to utilize bubbles having diameters in the range of 100 nanometers to 100 micrometers (microns). For moving between the systems of measurement, it may be noted that a cubic centimeter is about 0.06102 cubic inch, there are 231 cubic inches in a gallon, and a bubble having a diameter of 100 nanometers will have a volume of 523,598 cubic nanometers.

TABLE 4
Air and Pressure Associated with a Desired Density

| | weight of | weight of | volume of | volume of air² | | volume of air | volume of air |
|---|---|---|---|---|---|---|---|
| | Water | air | air | portion of a | | portion of a | portion of a |
| desired | portion¹ | portion | (std cubic | mixed gallon | pressure | mixed gallon | mixed gallon |
| density | of a gallon | of a gallon | feet) | (gallons) | (psi) | (cubic in) | (mm3) |
| 4 | 1.920768 | 2.079232 | 25.76495 | 0.769416 | 3213.358 | 177.735 | 2912555 |
| 4.1 | 2.018007 | 2.081993 | 25.79917 | 0.757742 | 3217.625 | 175.0385 | 2868366 |
| 4.2 | 2.117647 | 2.082353 | 25.80363 | 0.745781 | 3218.182 | 172.2753 | 2823087 |
| 4.3 | 2.219688 | 2.080312 | 25.77834 | 0.733531 | 3215.028 | 169.4456 | 2776716 |
| 4.4 | 2.32413 | 2.07587 | 25.7233 | 0.720993 | 3208.163 | 166.5493 | 2729255 |
| 4.5 | 2.430972 | 2.069028 | 25.63851 | 0.708167 | 3197.588 | 163.5865 | 2680702 |
| 4.6 | 2.540216 | 2.059784 | 25.52396 | 0.695052 | 3183.302 | 160.557 | 2631058 |
| 4.7 | 2.651861 | 2.048139 | 25.37967 | 0.681649 | 3165.306 | 157.461 | 2580324 |
| 4.8 | 2.765906 | 2.034094 | 25.20562 | 0.667958 | 3143.599 | 154.2984 | 2528498 |
| 4.9 | 2.882353 | 2.017647 | 25.00182 | 0.653979 | 3118.182 | 151.0692 | 2475581 |
| 5 | 3.0012 | 1.9988 | 24.76827 | 0.639712 | 3089.054 | 147.7734 | 2421573 |
| 5.1 | 3.122449 | 1.977551 | 24.50497 | 0.625156 | 3056.215 | 144.4111 | 2366474 |
| 5.2 | 3.246098 | 1.953902 | 24.21192 | 0.610312 | 3019.666 | 140.9821 | 2310283 |
| 5.3 | 3.372149 | 1.927851 | 23.88911 | 0.59518 | 2979.406 | 137.4866 | 2253002 |
| 5.4 | 3.5006 | 1.8994 | 23.53655 | 0.57976 | 2935.436 | 133.9245 | 2194630 |
| 5.5 | 3.631453 | 1.868547 | 23.15424 | 0.564051 | 2887.755 | 130.2959 | 2135166 |
| 5.6 | 3.764706 | 1.835294 | 22.74218 | 0.548055 | 2836.364 | 126.6006 | 2074612 |
| 5.7 | 3.90036 | 1.79964 | 22.30037 | 0.531769 | 2781.262 | 122.8388 | 2012966 |
| 5.8 | 4.038415 | 1.761585 | 21.82881 | 0.515196 | 2722.449 | 119.0103 | 1950230 |
| 5.9 | 4.178872 | 1.721128 | 21.32749 | 0.498335 | 2659.926 | 115.1153 | 1886402 |
| 6 | 4.321729 | 1.678271 | 20.79642 | 0.481185 | 2593.692 | 111.1537 | 1821483 |

¹The drilling fluid is assigned the density of water, 8.33 pounds per gallon. All of the desired densities in Table 4 are therefore less than 75% of the density of the base drilling fluid.
²Although Kepler's conjecture would seem to preclude complete uniformity of bubbles where the desired density is 4.2 or lower, it is believed the preponderance of bubbles will remain as discrete units, particularly where dispersants are used.

For Examples 5, 6, and 7, calculations were made showing the amounts of air and water used to achieve drilling fluid densities of 4, 5, and 6 over a range of anticipated pressures. The calculations use the standard weight of air as 0.08 pound per cubic foot. As in the other tables, a temperature of 100° F. is assumed throughout, the weight of water as 8.33 pounds per gallon, and air densities at the stated pressures are interpolated from data available on the Internet, specifically the Engineering Toolbox.

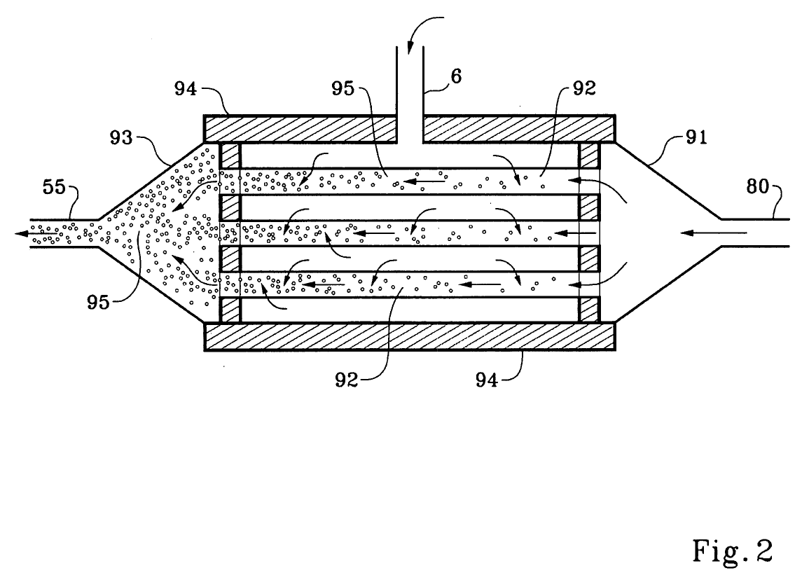

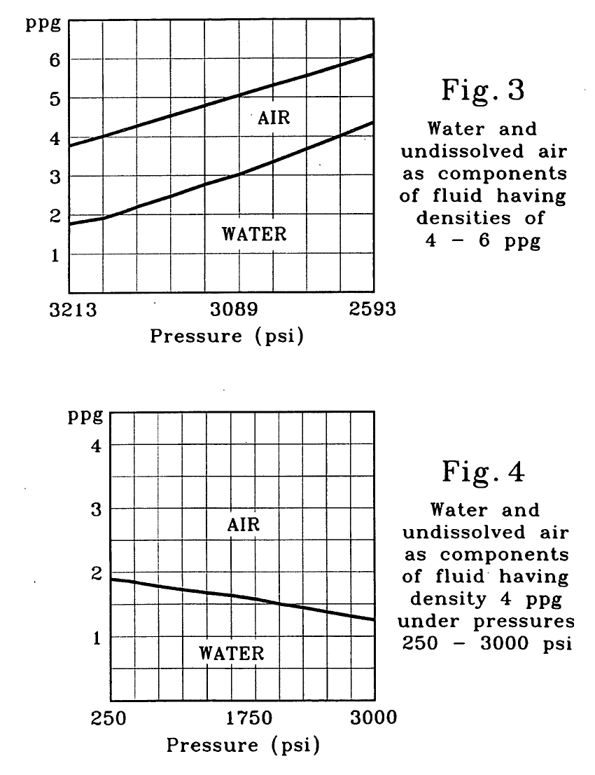

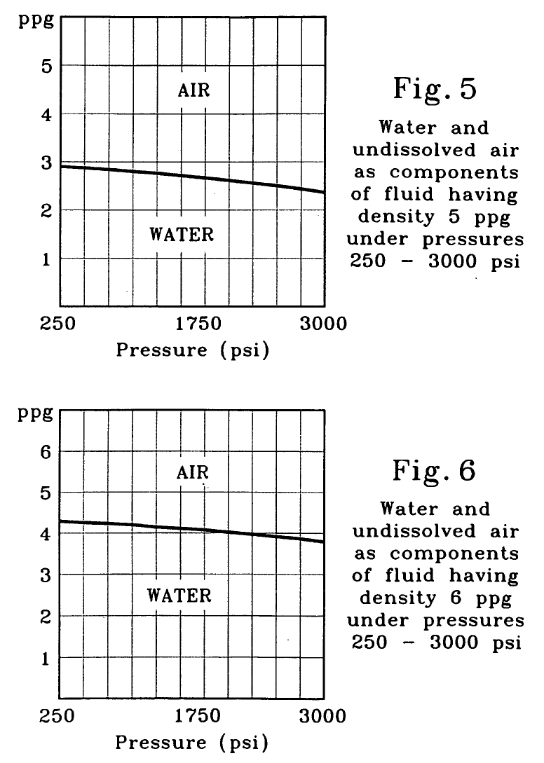

FIGS. 4, 5, and 6 are graphic representations of data from Tables 5, 6, and 7 respectively, relating to fluids having densities of 4, 5, and 6 respectively. The ratio of air to water decreases with increasing density of the product fluid, as seen in FIG. 3, but increases with increasing pressure at a given density.

TABLE 5
Relationship of Water and Air Obtaining a Density
of 4 pounds per gallon Over a Range of Pressures

| | | | water | air | air |
|---|---|---|---|---|---|
| | | | portion of | portion of | portion of |
| | | | a gallon | a gallon | a gallon |
| | air | air | having | having | having |
| | density | density | density 4 | density 4 | density 4 |
| pressure | (lb/ft3) | (ppg) | (pounds) | (pounds) | (std cu ft) |
| 250 | 1.278 | 0.170856 | 1.877228 | 2.122772 | 26.53465 |
| 500 | 2.483 | 0.331952 | 1.834472 | 2.165528 | 27.0691 |
| 750 | 3.688 | 0.493048 | 1.789957 | 2.210043 | 27.62554 |
| 1000 | 4.893 | 0.654144 | 1.743574 | 2.256426 | 28.20532 |
| 1250 | 6.098 | 0.815241 | 1.695202 | 2.304798 | 28.80997 |
| 1500 | 7.303 | 0.976337 | 1.644711 | 2.355289 | 29.44111 |
| 1750 | 8.508 | 1.137433 | 1.591958 | 2.408042 | 30.10052 |
| 2000 | 9.713 | 1.298529 | 1.536788 | 2.463212 | 30.79015 |
| 2250 | 10.918 | 1.459626 | 1.479031 | 2.520969 | 31.51211 |
| 2500 | 12.123 | 1.620722 | 1.4185 | 2.5815 | 32.26875 |
| 2750 | 13.328 | 1.781818 | 1.354991 | 2.645009 | 33.06261 |
| 3000 | 14.533 | 1.942914 | 1.288278 | 2.711722 | 33.89652 |

TABLE 6
Relationship of Water and Air Obtaining a Density
of 5 pounds per gallon Over a Range of Pressures

| | | | water | air | air |
|---|---|---|---|---|---|
| | | | portion of | portion of | portion of |
| | | | a gallon | a gallon | a gallon |
| | air | air | having | having | having |
| | density | density | density 5 | density 5 | density 5 |
| pressure | (lb/ft3) | (ppg) | (pounds) | (pounds) | (std cu ft) |
| 250 | 1.278 | 0.170856 | 2.959345 | 2.040655 | 25.50819 |
| 500 | 2.483 | 0.331952 | 2.918242 | 2.081758 | 26.02197 |
| 750 | 3.688 | 0.493048 | 2.87545 | 2.12455 | 26.55688 |
| 1000 | 4.893 | 0.654144 | 2.830861 | 2.169139 | 27.11424 |
| 1250 | 6.098 | 0.815241 | 2.78436 | 2.21564 | 27.6955 |
| 1500 | 7.303 | 0.976337 | 2.735822 | 2.264178 | 28.30222 |
| 1750 | 8.508 | 1.137433 | 2.68511 | 2.31489 | 28.93612 |
| 2000 | 9.713 | 1.298529 | 2.632074 | 2.367926 | 29.59907 |
| 2250 | 10.918 | 1.459626 | 2.576551 | 2.423449 | 30.29311 |
| 2500 | 12.123 | 1.620722 | 2.518362 | 2.481638 | 31.02048 |
| 2750 | 13.328 | 1.781818 | 2.457309 | 2.542691 | 31.78363 |
| 3000 | 14.533 | 1.942914 | 2.393177 | 2.606823 | 32.58528 |

TABLE 7
Relationship of Water and Air Obtaining a Density
of 6 pounds per gallon Over a Range of Pressures

| | | | water | air | air |
|---|---|---|---|---|---|
| | | | portion of | portion of | portion of |
| | | | a gallon | a gallon | a gallon |
| | air | air | having | having | having |
| | density | density | density 6 | density 6 | density 6 |
| pressure | (lb/ft3) | (ppg) | (pounds) | (pounds) | (std cu ft) |
| 250 | 1.278 | 0.170856 | 4.286585 | 1.713415 | 21.41769 |
| 500 | 2.483 | 0.331952 | 4.252074 | 1.747926 | 21.84908 |
| 750 | 3.688 | 0.493048 | 4.216143 | 1.783857 | 22.29821 |
| 1000 | 4.893 | 0.654144 | 4.178705 | 1.821295 | 22.76619 |
| 1250 | 6.098 | 0.815241 | 4.139661 | 1.860339 | 23.25424 |
| 1500 | 7.303 | 0.976337 | 4.098907 | 1.901093 | 23.76367 |
| 1750 | 8.508 | 1.137433 | 4.056327 | 1.943673 | 24.29592 |
| 2000 | 9.713 | 1.298529 | 4.011796 | 1.988204 | 24.85255 |
| 2250 | 10.918 | 1.459626 | 3.965176 | 2.034824 | 25.4353 |
| 2500 | 12.123 | 1.620722 | 3.916318 | 2.083682 | 26.04602 |
| 2750 | 13.328 | 1.781818 | 3.865056 | 2.134944 | 26.6868 |
| 3000 | 14.533 | 1.942914 | 3.811208 | 2.188792 | 27.3599 |

### EXAMPLE 8

### Field Demonstration

A field demonstration was successfully performed at a northeast Texas rig. Drilling was begun with a solids-free fluid having a density of 8.7 ppg. A pump pressure of 2000 psi was established at a 500 gpm flow rate. Then the drilling fluid was routed through a cavitation device having a connection for the introduction of compressed air. At first it was difficult to control the balance between the air and liquid because introduction of the air immediately reduced the liquid flow to as much as 25% below the original liquid flow rate. Using an air supply of 120 psi, a balance of liquid flow and air flow was established, resulting in a substantially steady fluid density of 8.0 ppg for several hours, during which standpipe pump pressure was reduced from 2000 psi to 1600 psi with no hole problems. Brief periods of equivalent density as low as 5 pounds per gallon were believed to have occurred.

The formation of micro bubbles can be enhanced by adding surfactants. Since we do not want “foam” we use surfactants that reduce the interfacial tension between the gas and liquid, but do not create voluminous foam structures. Useful surfactants include various products that have a low HLB (hydrophilic/lipophilic balance) such that they disperse in water, or are only slightly soluble in water. As is known in the art, a low HLB surfactant is one which is higher in oil solubility than it is in water solubility, and can be used to make water-in-oil emulsions. We may use N-dodecyl pyrrolidone (“Surfadone LP-300” from International Specialty Products); however, any surfactant low in water solubility (having a low HLB, i.e. lipophilic) will beneficially reduce the interfacial tension between the bubbles and the liquid. We use the term “low HLB value” in its normally accepted sense, to mean the surfactant is more soluble in oil than in water. Even a very small amount of low HLB value surfactant will be effective to a commensurate degree in dispersing the microbubbles in our aqueous fluids; larger amounts are correspondingly more effective, but since each material is somewhat different, the operator should be prepared to note when further increases result in decreasing improvement or a counterproductive side effect.

Furthermore the stability of the micro bubble suspension can be enhanced by viscosity using natural viscosity-enhancing polymers such as xanthan gum, hydroethylcellulose, carboxymethyl guar, starches, carboxymethylcellulose and other natural polymers and their derivatives. They may be used in combination; a mixture of carboxymethyl cellulose and xanthan gum is effective. The viscosity-enhancing polymer can be added before or after the SPR. Again, a very small amount of viscosity enhancing polymer will be effective to a commensurate degree in enhancing the viscosity of the fluid and correspondingly stabilizing the suspension of microbubbles; larger amounts are correspondingly more effective, but since each material is somewhat different, the operator should be prepared to note when further increases result in decreasing improvement or a counterproductive side effect.

The stability of the micro bubble suspension can also be enhanced by adding a charge to the surface of each bubble. Micro bubbles are being used extensively in the medical profession where stability is important. A number of additives are listed in the literature as being stabilizers for micro-bubble suspensions. One is such stabilizer is poly (allylamine hydrochloride) or PAH. We may use a copolymer of DADMAC/AA (diallyldimethylammonium chloride and acrylic acid); a copolymer of DADMAC/AA (diallyldimethylammonium chloride and acrylamide may also be used, any polymer capable of carrying an ionic charge may be used. Generally any polymer including amine or diallyl dimethyl ammonium chloride units can be used. The most readily available polymers impart an ionic charge by the presence of an ammonium group in the polymer. The cationic quaternary ammonium sites facilitate electrokinetics and electrophoresis commonly referred to as Zeta Potential. Similarly charged bubble surfaces will repel one another and help stabilize the suspension of bubbles. As with the low HLB dispersants and the viscosity-enhancing polymers, a very small amount of ionic charge carrying polymer will be effective to a commensurate degree in enhancing the viscosity of the fluid and correspondingly enhancing the stability of the suspension of microbubbles; larger amounts are correspondingly more effective, but since each material is somewhat different, the operator should be prepared to note when further increases result in decreasing improvement or a counterproductive side effect.

The Ideal Gas Law determines the amount of gas required to make up a given volume at any pressure. The bubbles will get smaller with increasing pressure and larger with decreasing pressure. Our goal is to maintain the bubbles within a size range such that they remain micron sized bubbles. Practically, smaller is better because they will expand in size as the fluid travels from the highest pressure (I assume that would be at the bit) to the lowest pressure (I assume that would be the blooey line) point at the surface. The gas may be air, nitrogen, methane natural gas, air treated to provide a gas having at least 90% nitrogen, Diesel exhaust, or any other convenient gas.

Since water is practically incompressible, a given density can be calculated by first picking a target weight in pounds per gallon. If you want a certain ppg fluid then you can simply solve (1—desired density/liquid density) to find the volume of gas required; however, you must define the volume of gas by pressure using the Ideal Gas Law, PV=nRT.

Normally drilling fluids heavier than water are prescribed in order to increase the specific gravity and provide enhanced buoyancy for the drill cuttings picked up by the fluid. Therefore it would seem to be counterintuitive to add microbubbles to such a fluid to reduce its weight; however, the same equation, and our invention, works whether one uses water or clear brine having a high density. In addition to friction reducing, an advantage of microbubbles in a dense clear brine may be that the bubbles may give more “lift” as the heavy fluid is returned up the wellbore. Thus our invention is able not only to reduce the weight of more or less conventional aqueous drilling fluids, but also fluids which are made dense for various reasons by the addition of heavy salts.

We use the terms liquid and base liquid and fluid for their ordinary meanings and for their meanings in the are of drilling wells. Since we do not intend to make foam, the terms non-contiguous and/or non-foam are intended to mean that the microbubbles are dispersed and do not contact each other in significant numbers.

Thus pir invention includes a drilling fluid for use in drilling wells comprising water and non-contiguous microbubbles in an amount sufficient to achieve drilling fluid weight within the range 4-6 pounds per gallon. Our invention also includes an aqueous drilling fluid under a pressure of at least 1000 pounds per square inch consisting essentially of (a) water in liquid form which may contain optional drilling fluid additives and ineluctable dissolved gas, and (b) by volume, from 20% to 73% gas in the form of substantially uniformly sized, substantially evenly dispersed non-foam microbubbles. The drilling fluid may contain, as an optional additive, a viscosity-enhancing polymer in an amount effective to inhibit coalescence among the microbubbles and/or a polymer containing quaternary ammonium mer units in an amount effective to impart mutual repellance by the microbubbles. In addition, our invention includes a syntactic microbubble drilling fluid having a density of 4-6 pounds per gallon, the drilling fluid comprising a base drilling fluid and substantially evenly dispersed microbubbles having substantially uniform diameters in the range of 100 nanometers to 100 microns.

1. A drilling fluid for use in drilling wells comprising water and non-contiguous microbubbles in an amount sufficient to reduce the weight of said liquid by at least 10%.

2. Drilling fluid of claim 1 wherein said microbubbles are air bubbles.

3. Drilling fluid of claim 1 wherein said microbubbles comprise natural gas.

4. Drilling fluid of claim 1 wherein said microbubbles comprise at least 90% nitrogen.

5. Drilling fluid of claim 1 including at least one of (a) an amount of low HLB surfactant effective to reduce interfacial tension between gas and liquid, (b) an amount of natural polymer or derivative thereof effective to enhance the viscosity of said fluid thereby enhancing the stability of said microbubbles, and (c) an amount of polymer containing an ionic charge effective to impart mutual repellance among said bubbles, said fluid being under a pressure in the range of 350 to 5000 pounds per square inch.

6. Drilling fluid of claim 1 wherein said microbubbles are of substantially uniform size and are substantially evenly dispersed in said water.

7. A drilling fluid of claim 1 wherein said microbubbles are non-foamed microbubbles having diameters of from 100 nanometers to 100 microns.

8. Drilling fluid of claim 7 wherein said liquid comprises water.

9. Drilling fluid of claim 7 wherein said microbubbles are air and are present in an amount sufficient to render the drilling fluid weight within the range 4-6 pounds per gallon.

10. Drilling fluid of claim 1 under a pressure of at least 350 pounds per square inch.

11. An aqueous drilling fluid under a pressure of at least 1000 pounds per square inch consisting essentially of (a) water in liquid form which may contain optional drilling fluid additives and ineluctable dissolved gas, and (b) by volume, from 20% to 73% gas in the form of substantially uniformly sized, substantially evenly dispersed non-foam microbubbles.

12. Aqueous drilling fluid of claim 11 including, as an optional drilling fluid additive to said water, a viscosity-enhancing polymer in an amount effective to inhibit coalescence among said microbubbles.

13. Aqueous drilling fluid of claim 11 including, as an optional drilling fluid additive to said water, a polymer containing quaternary ammonium groups in an amount effective to impart mutual repellance by said microbubbles.

14. Aqueous drilling fluid of claim 11 wherein said gas is air.

15. Aqueous drilling fluid of claim 11 wherein said gas is at least 90% by weight nitrogen.

16. Aqueous drilling fluid of claim 11 having a density in the range of 4-6 pounds per gallon.

17. A syntactic microbubble drilling fluid having a density of 4-6 pounds per gallon, said drilling fluid comprising a base drilling fluid and substantially evenly dispersed microbubbles having substantially uniform diameters in the range of 100 nanometers to 100 microns.

18. Syntactic microbubble drilling fluid of claim 17 wherein said base drilling fluid comprises water.

19. Syntactic microbubble drilling fluid of claim 17 wherein said base drilling fluid comprises oil.

20. Syntactic microbubble drilling fluid of claim 17 wherein said microbubbles have substantially uniform diameters in the range of 20-40 microns.
